(19) United States
(12) Patent Application Publication
(10) Pub. No.: US 2005/0091555 A1
(43) Pub. Date: Apr. 28, 2005

(54) Abstraction generation for hierarchical timing analysis using implicity connectivity graph derived from domain propagation

(76) Inventors: Tong Xiao, San Jose, CA (US); Robert E. Mains, Morgan Hill, CA (US)

Correspondence Address: HAMILTON & TERRILE, LLP, P.O. BOX 203518, AUSTIN, TX, 78720, US

(21) Appl. No.: 10/694,139

(22) Filed: Oct. 27, 2003

(51) Int. Cl. G06F 1/04

(52) U.S. Cl. 713/500

(57) ABSTRACT

A method of using static timing analysis to extract implicit connectivity graph information. The method includes creating a unique clock waveform, defining a clock domain for the clock waveform, injecting the clock domain into a control node, propagating timing events from the control node to a transitively adjacent observation node, and retrieving transitively adjacent control node information to determine path delay information from the control node to the transitively adjacent observation node based upon propagation of timing events.

### BACKGROUND OF THE INVENTION

1. Field of the Invention

The present invention relates to integrated circuit timing analysis and more particularly, to abstraction generation for a hierarchical timing analysis.

2. Description of the Related Art

Known very large scale integrated (VLSI) circuit designs, and in particular microprocessors designs, often include millions of logic gates which represent upwards of 100 million transistors. An important step in the design process of a microprocessor is the performance of static timing analysis, which measures the frequency of the design. The static timing analysis enables designers to identify critical paths that may require additional design work to meet performance objectives. Performing static timing on such large designs at the detailed gate level often results in very long run times, significantly slowing the design process and thus potentially leading to reduced time to market and loss of revenue.

To improve the runtime of static timing analysis, the timing behavior of a given block in the integrated circuit design hierarchy may be represented by a model generated from the lower level gates. For example, FIG. 1, labeled Prior Art, shows a hierarchical diagram of model of an exemplative integrated circuit chip. The model of the exemplative integrated circuit chip includes a data path 110, a control block 120, a custom block 130, and memory 140. In this model, a custom block 150 and a data path block 160 are abstracted. Providing an abstract timing model in the context of a full chip timing run enables more rapid analysis than if the detailed representation was used, as well as providing a reduced memory footprint. This approach may also be useful when performing timing optimization on part of a design.

The timing behavior of a block can be represented by different methods. More specifically, the timing behavior of a block can be represented as a delay matrix in which the delay and slew from each input to each output is explicitly listed. Alternately, the timing behavior of a block can be represented as a delay network in which a simplified network is provided; the simplified network has the same timing behavior as the original network in the hierarchical timing analysis.

The process of creating a timing model is referred to as abstraction generation or timing model generation. One important issue in abstraction generation is path extraction. Path extraction relates to the issue of efficiently enumerating paths from the inputs to the outputs of a block, often referred to as the timing graph, the signal propagation graph or the connectivity graph, and determining the timing behavior of the paths represented by the graph. The issue can be formulated as follows: For any two nodes, node A and node B in the design, given an input slew and an input switching direction at node A, and given a load capacitance at node B, the timing behavior should determine the switching direction at node B, and determine delay between node A and node B.

Different approaches have been proposed to address the model generation problem. For example, paths may be explicitly enumerated to determine whether there is a path from node A to node B, with the path delay computed during tracing. Because the number of paths to trace grows exponentially with the number of nodes in the design, this approach can lead to prohibitively long runtimes for very large circuits.

Alternately, a series of circuit timing graph transformations may be performed by iteratively removing pins and merging arcs until no further change is possible. This process yields a compressed delay analysis graph which encapsulates the original circuit's timing behavior. However, this technique suffers from complexity in the reduction algorithm; i.e., the process does not lend itself to modeling graph topologies containing time borrowing elements that yield topological loops.

### SUMMARY OF THE INVENTION

The present invention relates to extracting timing model information using an underlying static timing analyzer infrastructure based upon the usage of time domain signal propagation while performing static timing analysis. More specifically, the present invention relates to providing a clock domain injection per primary input or pseudo primary input along with the capability of an underlying static timing engine to retrieve the minimum and maximum path delay arcs from primary input to flop, primary input to primary output, and flop to primary output. The extracted path delay arcs are then employed to represent the delay behavior of the macro under analysis, and thus to implicitly generate connectivity graph information, without having to perform graph tracing or reduction.

In one embodiment, the invention relates to a method of using static timing analysis to extract implicit connectivity graph information. The method includes creating a unique clock waveform, defining a clock domain for the clock waveform, injecting the clock domain into a control node, propagating the clock waveform from the control node to a transitively adjacent observation node, and retrieving transitively adjacent control node information to determine path delay information from the control node to the transitively adjacent observation node based upon propagation of the clock waveform.

In another embodiment, the invention relates to a system for using static timing analysis to extract implicit connectivity graph information. The system includes means for creating a unique clock waveform, means for defining a clock domain for the clock waveform, means for injecting the clock domain into a control node, means for propagating the clock waveform from the control node to a transitively adjacent observation node, and means for retrieving transitively adjacent control node information to determine path delay information from the control node to the transitively adjacent observation node based upon propagation of the clock waveform.

In another embodiment, the invention relates to an apparatus for using static timing analysis to extract implicit connectivity graph information. The apparatus includes a clock waveform module, the clock waveform module creating a unique clock waveform, a clock domain module, the clock domain module defining a clock domain for the clock waveform, an injecting module, the injecting module injecting the clock domain into a control node, a propagating module, the propagating module propagating the clock waveform from the control node to a transitively adjacent observation node, and a retrieving module, the retrieving module retrieving transitively adjacent control node information to determine path delay information from the control node to the transitively adjacent observation node based upon propagation of the clock waveform.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1, labeled Prior Art, shows a block diagram of a hierarchical model of an exemplative integrated circuit chip.

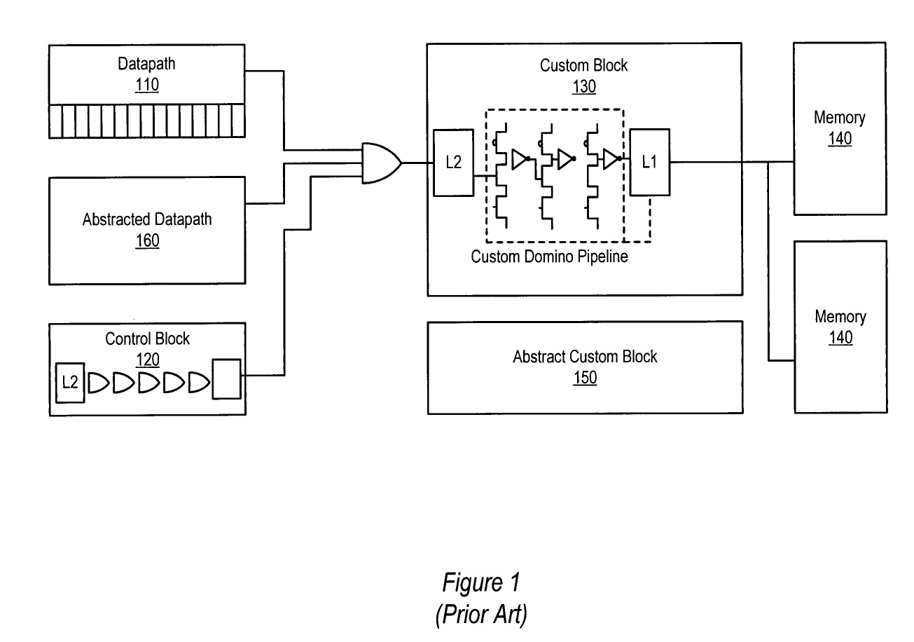

FIG. 2 shows an example of the timing of a pair of exemplative signals.

FIG. 3 shows a block diagram of an integrated circuit topology which includes control and observation nodes.

FIG. 4 shows a flow chart showing the operation of a path delay extraction system.

FIG. 5 shows flow chart of the operation a path delay module.

FIG. 6 shows a flow chart of the operation a timing constraint module.

### DETAILED DESCRIPTION

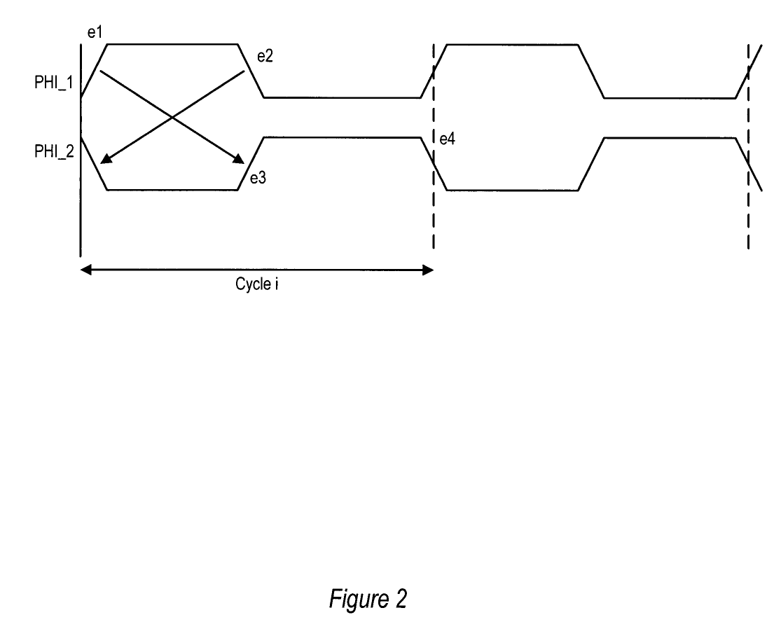

Referring to FIG. 2, a domain in static timing analysis is defined to be a timing event derived from a clock waveform specification which includes a reference time and a direction within a clock cycle. A given clock defines two domains: one for each clock pulse edge. Each signal in an integrated circuit design is governed by a domain. Signals with different domains are kept distinct, i.e., the signals do not interact with one another while propagating through nets and combinational logic. Combinational edges propagate domains unmodified. Sequential edges do not. Sequential flip-flop edges (clock to out) propagate the domain of the triggering clock edge. Sequential latch-edges (clock-to-out or data-to-out) propagate the domain of the opening edge of the clock pin. This is known as clock to data domain conversion. FIG. 2 shows the creation of clock domains for the clock PHI_1, and its logical inverse, PHI_2. Where PHI_1 is the master clock definition with event edges e1 and e2 and PHI_2 is a derived clock definition with event edges e3 and e4. Event edges e1 and d3 are positive edge events and event edges e2 and e4 are negative edge events.

From the clock edge event definition, timing events known as waves are created to represent the clock and data propagation values of arrival time, transition time, and switching direction. The propagation of timing events results in the construction of an implicit, event based, propagation graph for the extraction of timing critical paths for model generation, where point to point paths are derivable from the domain based analysis graph.

To determine whether there is a timing path between two nodes, node A and node B, a static timing analysis process is performed on the nodes. More specifically, a set of control nodes in the static timing graph is defined to be either the primary inputs or pseudo primary inputs (a pseudo primary input is an output from an immediately previous sequential element). A timing domain event can be initiated from a primary input or a pseudo primary input. A given control node is identified as node A. The set of observation nodes in the timing graph is defined to be either the primary outputs of the design under analysis, or the input of a sequential element. A given observation node is identified as node B.

Sequential elements have a dual function. The sequential elements may function as a control node and as an observation node (an input of a sequential element may function as an observation node while the output of the sequential element may function as a control node. The analysis graph is topologically sorted such that nodes are in an ordered fashion yielding an acyclic analysis graph which can be transversed from left to right.

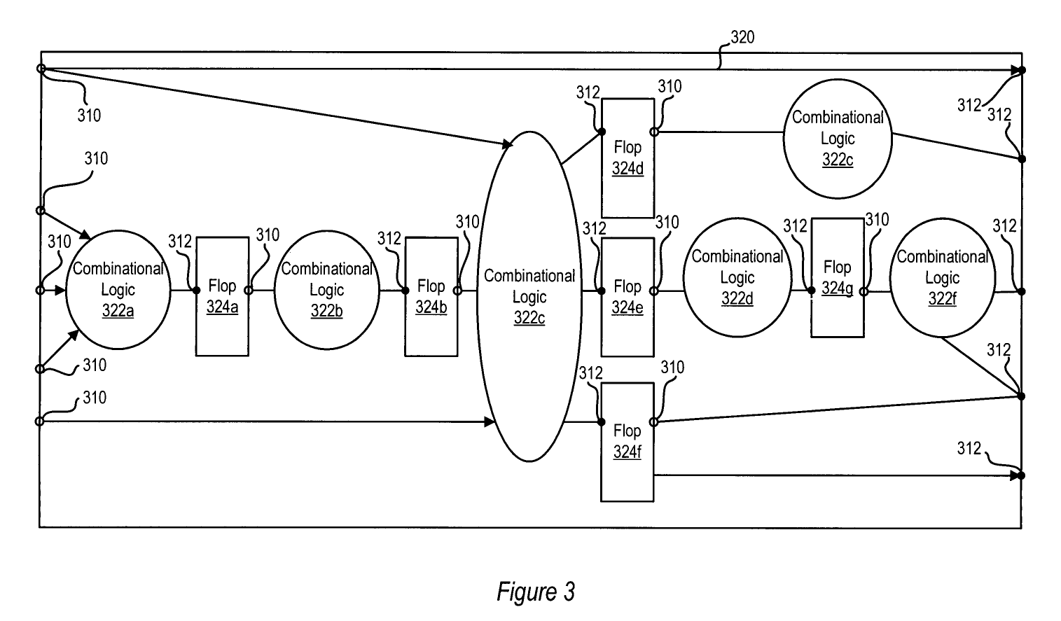

FIG. 3 shows the concept of transitively adjacent control and observation nodes for an example design. Control nodes 310 are represented as opaque circles and observation nodes 312 are represented as black circles. The lines and arrows represent potential paths between the transitively adjacent control nodes 310 and observation nodes 312 that are uncovered by the abstraction generation process in accordance with the present invention.

More specifically, the path between a control node 310 and an observation node 312 may be via a direct path as represented by line 320, thus these nodes are transitively adjacent. The path between a control node 310 and a transitively adjacent observation node 312 may be via combinational logic 322, via a flop 324 or via some combination of combinational logic 322 and flops 324. Also, some observation nodes may also provide a pseudo control node when passing via a sequential element. For example, the observation node at the input of flop 324a provides a pseudo control node which is the input to combinational logic 322b.

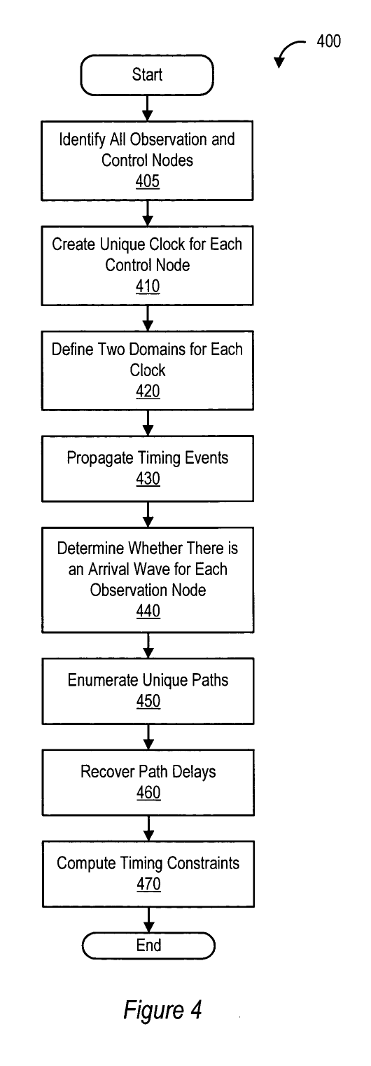

Referring to FIG. 4, a flow chart showing the operation of a abstraction generation system 400 is shown. More specifically, the method starts by identifying all observation and control nodes at step 405 and proceeds with creating a unique clock i for each control node i at step 410. Next, two domains are defined for each clock i at step 420. Domain i+ is defined by rising edge of clock i, and domain i− is defined by falling edge of clock i. The static timing engine then propagates timing events created with the unique clock domain from each control node i at step 430.

Next, at step 440, the method determines whether, for each observation node j, there is an arrival wave of domain i+ and i−.

By using a static timing engine, unique paths are implicitly enumerated from each control node to the set of affected observation nodes. Thus, at step 460 the method recovers the path delay from each control node to the set of transitively adjacent observation nodes such that the path delay is recovered between node i and node j.

Once the path is extracted for a pair of control node i and observation node j, timing constraints are computed at step 470. The timing constraints may include setup constraints or hold constraints. After the timing constraints are computed, the execution of the abstraction generation system 400 completes.

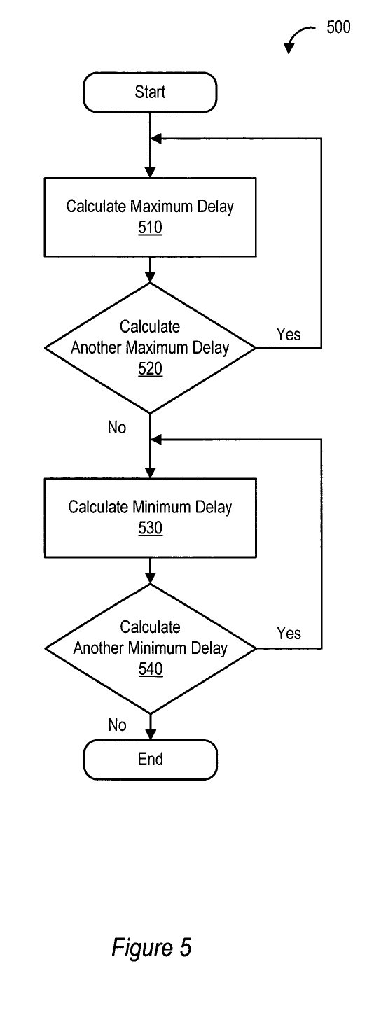

Referring to FIG. 5, a flow chart of the operation a path delay module 500 of the abstraction generation system 400 in recovering path delays is shown. A plurality of different types of path delays may be recovered. The module 500 begins execution at step 510 by calculating a maximum delay from each control node to the set of adjacent observation nodes such that the path delay between node i and node j is computed as:
MaxΔi(i, j)_{R-R}=α_{LR}_{_{—}}ᵢ₊(j)−α_{LR-i+}(i)
where MaxΔi(i, j)_{R-R} is the maximum delay from node i rising to node j rising;
α_{LR-i+}(j) is the latest arrival time at node j rising from domain i+ if it is present at nodej;
α_{LR}_{_{—}}ᵢ₊(i) is the launch time of domain i+ at node i.

Next the abstraction generation system determines whether to calculate another maximum path delay at step 520. Other types of maximum path delays include, e.g., the maximum delay from node i rising to node j falling, the maximum delay from node i falling to node j rising, and the maximum delay from node i falling to node j falling. If other maximum delays are to be calculated, then control returns to step 510 and these maximum delays are calculated as the maximum path delay between node i rising to node j rising was calculated. If no other maximum delays are to be calculated, then control proceeds to step 530.

The minimum delay is calculated at step 530. For example, the minimum delay from node i to node j can be computed as follows:
MinΔi(i, j)_{R-R}=α_{ER}_{_{—}}ᵢ(j)−α_{ER}_{_{—}}ᵢ₊(i)
where MinΔi(i, j)_{R-R} is the minimum delay from node i rising to node j rising;
α_{ER-i+}(j) is the earliest arrival time a node j rising from domain i+ if it is present at node j;
α_{ER-i+}(i) is the launch time of domain i+ at node i.

Next, the abstraction generation system determines whether to calculate other minimum delays at step 540. Other types of minimum path delays, e.g., the minimum delay from node i rising to node j falling, the minimum delay from node i falling to node j rising, and the minimum delay from node i falling to node j falling. If other minimum delays are to be calculated, then control returns to step 510 and these minimum delays are calculated as the minimum path delay between node i rising to node j rising was calculated.

If no other minimum delays are to be calculated, then the execution of the path delay module completes.

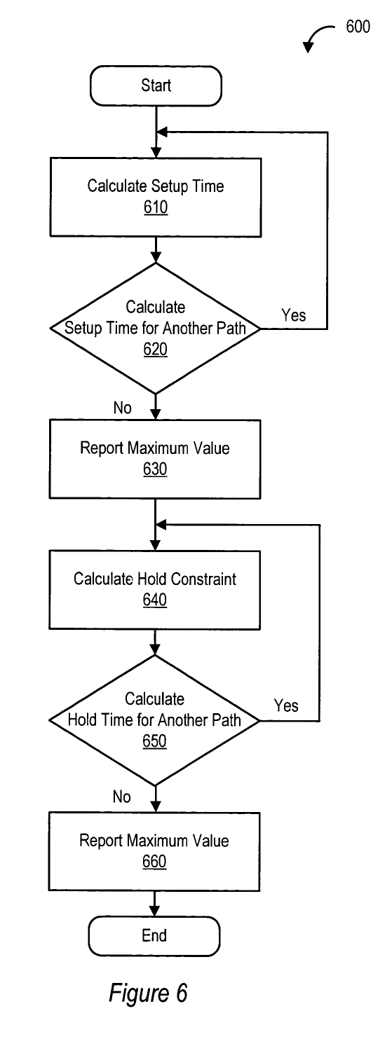

Referring to FIG. 6, a flow chart of the operation a timing constraint module 600 of the abstraction generation system in computing timing constraints is shown. In timing model generation, once the path is extracted for a pair of control node i and observation node j, timing constraints can be computed.

The timing constraints computed by the timing constraint module 600 include setup constraints and hold constraints. The timing constraints at node i can be computed from node j, if there is a path from node i to node j, and there is a pre-defined timing constraint at node j. Node j may have a pre-defined timing constraint, such as a setup check or a hold check at an input to a flop, or at an input to a latch.

Step 610 calculates a setup constraint at node i as follows:
Setup(i, clk)_{R-R}=MaxΔi(i, j)_{R-R}+Setup(j, clk)_{R-R}
where Setup(i, clk)_{R-R} is the setup time at node i rising relative to clock signal clk rising;
MaxΔi(i, j)_{R-R} is the maximum path delay from node i rising to node j rising;
Setup(j, clk)_{R-R} is the setup time at node j rising relative to clock signal clk rising.

Because there may be multiple paths between node i and node j for which the setup time is calculated, the module then checks to determine whether to calculate a setup time for another path at step 620. The setup time at node i can be computed from multiple paths from node i to transitively adjacent, and the maximum value (i.e., the most stringent setup time) is reported as setup constraint at node i at step 630.

Step 640 calculates the hold constraint at node i as follows:
Hold(i,clk)_{R-R}=Hold(j, clk)_{R-R}−MinΔi(i, j)_{R-R}
where Hold(i, clk)_{R-R} is the hold time at node i rising relative to clock signal clk rising;
Hold(j, clk)_{R-R} is the hold time at node j rising relative to clock signal clk rising.
MinΔi(i, j)_{R-R} is the minimum path delay from node i rising to node j rising;

Because there may be multiple paths between node i and node j for which the hold time is calculated, the module 600 then checks to determine whether to calculate a hold time for another path at step 650. The maximum value for the calculated hold time (i.e., the most stringent hold time) is reported as the hold constraint at node i at step 660.

After the maximum value of the calculated hold time is reported, then the execution of the timing constraint module 600 completes.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Also, for example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

1. A method of using static timing analysis to extract implicit connectivity graph information comprising:
creating a unique clock waveform;
defining a clock domain for the clock waveform;
injecting the clock domain into a control node;
propagating the clock waveform from the control node to a transitively adjacent observation node; and
retrieving transitively adjacent control node information to determine path delay information from the control node to the transitively adjacent observation node based upon propagation of the clock waveform.

2. The method of claim 1 wherein:
the clock domain includes a rising edge clock domain and a falling edge clock domain; and,
the path delay information includes information relating to the rising edge clock domain and the falling edge clock domain.

3. The method of claim 1 wherein:
the transitively adjacent observation node becomes a pseudo control node.

4. The method of claim 1 wherein:
the connectivity graph includes information a path between the control node and the transitively adjacent observation node.

5. The method of claim 1 wherein:
the path between the control node and the transitively adjacent observation node is a direct path.

6. The method of claim 1 wherein:
the path between the control node and the transitively adjacent observation node includes combinational logic.

7. The method of claim 1 wherein:
the path between the control node and the transitively adjacent observation node includes a flop.

8. The method of claim 1 wherein:
the path delay information includes timing constraint information.

9. The method of claim 8 wherein:
the timing constraint information includes setup constraint timing constraint information.

10. The method of claim 8 wherein:
the timing constraint information includes hold constraint timing constraint information.

11. A system for using static timing analysis to extract implicit connectivity graph information comprising:
means for creating a unique clock waveform;
means for defining a clock domain for the clock waveform;
means for injecting the clock domain into a control node;
means for propagating the clock waveform from the control node to a transitively adjacent observation node; and
means for retrieving transitively adjacent control node information to determine path delay information from the control node to the transitively adjacent observation node based upon propagation of the clock waveform.

12. The system of claim 11 wherein:
the clock domain includes a rising edge clock domain and a falling edge clock domain; and,
the path delay information includes information relating to the rising edge clock domain and the falling edge clock domain.

13. The system of claim 11 wherein:
the transitively adjacent observation node becomes a pseudo control node.

14. The system of claim 11 wherein:
the connectivity graph includes information a path between the control node and the transitively adjacent observation node.

15. The system of claim 11 wherein:
the path between the control node and the transitively adjacent observation node is a direct path.

16. The system of claim 11 wherein:
the path between the control node and the transitively adjacent observation node includes combinational logic.

17. The system of claim 11 wherein:
the path between the control node and the transitively adjacent observation node includes a flop.

18. The system of claim 11 wherein:
the path delay information includes timing constraint information.

19. The system of claim 18 wherein:
the timing constraint information includes setup constraint timing constraint information.

20. The system of claim 18 wherein:
the timing constraint information includes hold constraint timing constraint information.

21. An apparatus for using static timing analysis to extract implicit connectivity graph information comprising:
a clock waveform module, the clock module creating a unique clock waveform;
a clock domain module, the clock domain module defining a clock domain for the clock waveform;
an injecting module, the injecting module injecting the clock domain into a control node;
a propagating module, the propagating module propagating the clock waveform from the control node to a transitively adjacent observation node; and
a retrieving module, the retrieving module retrieving transitively adjacent control node information to determine path delay information from the control node to the transitively adjacent observation node based upon propagation of the clock waveform.

22. The apparatus of claim 21 wherein:
the clock domain includes a rising edge clock domain and a falling edge clock domain; and,
the path delay information includes information relating to the rising edge clock domain and the falling edge clock domain.

23. The apparatus of claim 21 wherein:
the transitively adjacent observation node becomes a pseudo control node.

24. The apparatus of claim 21 wherein:
the connectivity graph includes information a path between the control node and the transitively adjacent observation node.

25. The apparatus of claim 21 wherein:
the path between the control node and the transitively adjacent observation node is a direct path.

26. The apparatus of claim 21 wherein:
the path between the control node and the transitively adjacent observation node includes combinational logic.

27. The apparatus of claim 21 wherein:
the path between the control node and the transitively adjacent observation node includes a flop.

28. The apparatus of claim 21 wherein:
the path delay information includes timing constraint information.

29. The apparatus of claim 28 wherein:
the timing constraint information includes setup constraint timing constraint information.

30. The apparatus of claim 28 wherein:
the timing constraint information includes hold constraint timing constraint information.
